(19) United States
(12) Patent Application Publication
(10) Pub. No.: US 2016/0107495 A1
(43) Pub. Date: Apr. 21, 2016

(54) Wrap

(71) Applicant: SAF-HOLLAND GMBH, Bessenbach (DE)

(72) Inventors: Rolf Spielmann, Wertheim-Bettingen (DE); Roger Jansen, III, Holton, MI (US)

(73) Assignee: SAF-HOLLAND GmbH, Bessenbach (DE)

(21) Appl. No.: 14/890,795

(22) PCT Filed: Jun. 27, 2014
(86) PCT No.: PCT/EP2014/063677

§ 371 Date: Nov. 12, 2015

(30) Foreign Application Priority Data
Jun. 28, 2013 (DE) 10 2013 212 545.3

(51) Int. Cl. B60G 7/00

(52) U.S. Cl. CPC B60G 7/008; B60G 2204/148; B60G 2204/43; B60G 2206/8201

(57) ABSTRACT

A wrap for attaching a trailing arm to an axle tube, having a substantially tubular cross-section that extends along a longitudinal axis, an outer contour and an inner contour, having an internal diameter, the wrap having a compensation portion extending substantially along a longitudinal axis, and configured to modify the internal diameter , wherein the compensation portion includes at least one of an inner gap having a gap width and arranged at the inner contour and an outer gap having a gap width and arranged at the outer contour configured to modify the internal diameter, the gaps extending substantially along the circumferential direction of the wrap, and wherein the internal diameter may be modified by modifying the gap widths.

### BACKGROUND OF THE INVENTION

The present invention relates to a wrap for attaching a suspension arm or trailing arm to an axle tube, a method of manufacturing a compound of trailing arm and axle tube as well as a trailing arm for an axle tube.

Such wraps are as a rule used in the field of vehicle axles, in particular rigid axles (controlled or uncontrolled). As a rule, such vehicle axles consist of an axle tube and two trailing arms, which form the connection with a vehicle frame or chassis. Due to the wraps the trailing arms need not be welded directly to the axle tube, which would have a negative influence on the service life thereof. Instead, the trailing arms are welded onto the wraps, which are in turn connected to the axle tube. It is a problem that the axle tubes or the outer diameters thereof are subject to certain tolerances due to the manufacturing process. Thus, it cannot be ensured that the wraps can be arranged on the axle tubes in an ideally form-fitting manner, for example. In order to make it possible that the wraps nevertheless are sufficiently well seated on the axle tube, further finishing work of the wraps or of the axle tubes is necessary or different wraps with different internal diameters have to be provided. It is also important that, when the wraps are welded, no heat or only very little heat is introduced into the axle tube.

Therefore, the object underlying the present invention is to provide a wrap for attaching a trailing arm to an axle tube, a method of manufacturing a compound of trailing arm and axle tube as well as a trailing arm for a vehicle axle, which can be arranged without gap(s) on different axle tube diameters and which minimize a heat input from the wrap into the axle tube during welding.

### SUMMARY OF THE INVENTION

According to the invention, a wrap for attaching a trailing arm to an axle tube has a substantially tubular cross-section, which extends along a longitudinal axis and which has an outer contour and an inner contour, wherein the inner contour has an internal diameter, and wherein the wrap has at least one compensation portion, which extends substantially along the longitudinal axis, and wherein the at least one compensation portion is designed to modify the internal diameter by way of different adjustments. Axles or rigid axles, both controlled and uncontrolled, nowadays as a rule consist of five components, i.e. an axle tube, a left and a right axle stub, and the wraps. As a rule, such an axle is pivotably connected to the vehicle frame or to the chassis by means of two trailing arms or suspension arms. Trailing arms or suspension arms (hereinafter referred to as trailing arms only) are directed substantially along the direction of travel. The axle tube, along which the longitudinal axis is directed, is arranged at the trailing arms or in the trailing arms substantially transverse to the trailing arms or to the direction of travel. Preferably, they are arranged not directly, but indirectly by means of the wraps. Thus, advantageously, the wrap is arranged on the axle tube in a respective position, while the trailing arm is fixed to the wrap. Preferably, the trailing arms are welded in a circumferential manner to the wraps, which advantageously are in turn connected to the axle tube by means of laterally arranged welded joints. It is also possible to design the wrap as an integral part of the trailing arm, in that the trailing arm and the wrap are formed by means of a single cast body, for example. Advantageously, the trailing arms thus forms the wrap or a corresponding accommodation, which is adapted for arranging and fixing an axle tube. Here, the wrap or the accommodation may form part of the trailing arm, which is already formed during manufacture, such as in the case of the above-described cast body. Also preferably, the trailing arm may also be connected to the wrap or to the accommodation in a form-fitting and/or force-fitting manner and/or by means of a substance-to-substance bond so that it becomes “retroactively” so to say an integral part of the trailing arm. All advantages and features of the wrap apply in the same manner to the accommodation and vice versa. In order to avoid repetitions, only the term “wrap” is used hereinafter. Particularly preferably, in order to fix the wrap to the axle tube, a plug weld is used. To this end, in a preferred embodiment, the wrap advantageously has at least one hole in its circumference, which in the mounted state of the axle tube is positioned preferably at the upper side and/or at the bottom side of the wrap. The trailing arm(s) is/are fixed to the wrap(s) arranged or attached in this way. This makes it advantageously possible that the circumferential welded joint, which is used to fix the trailing arm, need not be directly on the axle tube, which would weaken the axle tube and, thus, possibly lead to a failure of the axle tube in field use due to the notching effect and the heat influence of the welded joint. Preferably, thus, the welded joints on the axle serving for fixing the wrap to the axle tube are all in the area of the vertical plane in the travel position of the axle. The use of the wraps has substantially two advantages: on the one hand, the welded joint is moved on the axle tube into an uncritical area and, on the other hand, the axle tube is reinforced in the area of the welded joint. In order to allow for a very long service life of the axle tube or of the connection between the trailing arms and the axle tube or the wraps, an entwinement of the wrap about the axle tube should be complete and without gap(s). Wraps known from the prior art surrounding the axle tube need to have different circumferences or diameters so as to suit the different available axle tube diameters without gap(s). By contrast, the wrap of the invention, which has the at least one compensation portion, is adapted to modify the internal diameter by different settings. Advantageously, by means of the compensation portion, the wrap is adapted to modify the internal diameter by means of an adjustment force directed substantially along the circumferential direction. So to say, the adjustment force causes the wrap to be compressed so that the internal diameter of the wrap is adapted to the outer diameter of the axle tube or to the axle tube as largely as is possible over the entire circumference thereof and the entire length of the wrap, which is dimensioned substantially along the axle tube. Advantageously, after the internal diameter of the wrap has been optimally adapted to the outer diameter of the axle tube, the wrap is locked, in particular welded or the like, for example. Preferably, the compensation portion extends over the entire length of the wrap. It can be arranged axis-parallel, but need not be arranged axis-parallel. Further preferably, in the area of the compensation portion, in a radial direction between the outer contour and the inner contour, a boundary area is provided. Here, the boundary area makes it possible that the wrap, which is welded in the area of the compensation portion, for example, prevents that molten material, for example, flows in the direction of the inner contour of the wrap and, thus, in the direction of the axle tube. The boundary area so to say represents a lock or a seal for any locking agent(s) used for locking the wrap. In addition, the boundary area also serves as a thermal barrier, thus, preventing a damaging and high heat input into the axle tube. The boundary area may advantageously also be formed similar to a labyrinth seal. Thus, it need not be “closed”, but only be dimensioned such that the weld pool may not advance from the outer contour to the inner contour, for example. Advantageously, the boundary area acts in the radial and/or axial direction and/or substantially in the circumferential direction. Advantageously, the use of the wrap helps to avoid a damaging notching effect onto the axle tube. To put it differently, the wrap is adapted to form two states. The states are defined such that the internal diameter of the wrap in a first state is different from an internal diameter in a second state. Advantageously, in the second state, the internal diameter is smaller than in the first state, but it may also be larger.

Advantageously, the wrap is formed such that at least in a certain area it is substantially free of gap(s) in a circumferential direction and/or transverse thereto when the internal diameters are differently adjusted. In particular, this refers to that area of the wrap, where the wrap is welded, for example. In particular, this thus refers to the absence of gaps in the area of the compensation portion. To put it differently, in the circumferential direction of the wrap and radially thereto there is preferably always at least one area, in which the wrap is designed continuously. Here, “continuously” means that when the wrap has a parting line, for example, the end portions formed hereby contact each other at least in portions or are so close to one another that the area may take over the function of the boundary area.

Preferably, the compensation portion, by means of at least one respective inner gap arranged at the inner contour and/or an outer gap arranged at the outer contour, is adapted to modify the internal diameter. Thus, preferably, the compensation portion comprises at least one inner gap and/or at least one outer gap. The outer gap arranged at the outer contour extends from the outer contour substantially radially in the direction of the inner contour. Accordingly, the inner gap arranged at the inner contour extends from the inner contour radially in the direction of the outer contour. Preferably, the inner gap and/or the outer gap, or in summary also “the gaps”, extend substantially along the longitudinal axis of the wrap. A height of the inner gap or of the outer gap, which is dimensioned in the radial direction of the wrap, preferably occupies one half to one sixth of a thickness of the wrap in this area. However, preferably, the inner gap and the outer gap may merge into each other such that they form a (continuous) gap so to say. The gap then extends advantageously continuously between the outer contour and the inner contour. A parting line forms due to the continuous gap.

Further preferably, the gaps (the inner gap, the outer gap and/or also the continuous gap) substantially along the circumferential direction of the wrap have gap widths, wherein the internal diameter may be modified by modifying the gap widths (or the gap width). Preferably, the gap widths may be modified by means of the adjustment force. In the second state of the wrap, the gap widths or the at least one gap width, are preferably smaller than in the second state. If the wrap is expanded, the gap widths or at least one gap width may also be larger in the second state. The gap width need not be constant along the height of the gaps.

Preferably, the gap width of the at least one outer gap substantially corresponds to the gap width of the at least one inner gap. Particularly preferably, two inner gaps are arranged at the inner contour. However, it is also possible to arrange three, four, five, six, seven or more gaps in the circumferential direction of the wrap. Particularly preferably, one outer gap is arranged at the outer contour. However, it is also possible to arrange two, three, four, five, six, seven or more gaps in the circumferential direction of the wrap. Advantageously, the sum of the gap widths of the inner gaps corresponds in total approximately to the gap widths of the outer gaps arranged at the outer contour. Two subsequent gaps in the circumferential direction are preferably separated by webs and/or possibly also intermediate areas described in more detail hereinafter.

Preferably, the compensation portion has at least one parting line extending substantially along the longitudinal axis and forming at least two end portions on the wrap. The end portions extend, following the parting line, also substantially along the longitudinal axis of the wrap. Here, it is decisive that in the preferred embodiment of the wrap, the latter is not separated such that two halves are formed. The parting line is only formed such that the wrap is separated circumferentially at least in a certain area. The end portions may be in contact. If they are not in contact, a continuous gap is formed.

Advantageously, the compensation portion or each end portion has at least one projection extending substantially along the circumferential direction of the wrap and wherein at least two projections engage into each other such that the inner gap and the outer gap are formed. Preferably, thus, two projections at least in a certain area engage into each other in a substantially form-fitting manner. Here, the projections are advantageously arranged such that the projections form at least one respective gap with the inner contour or with the outer contour. By compressing the wrap, the gaps make it now possible to modify the internal diameter. The projections advantageously engage into each other such that the wrap is formed substantially free from gap(s) at least in a certain area. In this way, the already described boundary area is formed, which makes it possible to create a barrier between the outer contour and the inner contour of the wrap. Advantageously, in the circumferential direction, a mobility of the projections relative to each other is made possible, which modifies the gap widths, by means of which the internal diameter may be finally adjusted, while at the same time the projections engage into each other such that a boundary area is formed.

Preferably, the boundary area is formed as a substantially radial portion arranged substantially parallel to the inner contour and to the outer contour. Also preferably, the boundary area may also be arranged inclined, i.e. indeed not parallel to the inner or outer contour, due to the projections. As a matter of course, it is also possible to arrange three, four, five, six or more projections at each end portion. It has already been described before that in a preferred embodiment the wrap is adapted to the axle tube diameter by compressing it and, then, e.g. welded accordingly. Alternatively preferably, the wrap may also be dimensioned such that it is expanded automatically by the axle tube to the ideal internal diameter by sliding it onto the axle tube. Thus, it is not required to use an adjustment force. This is made possible in that the projections are movable one within the other, i.e. in the circumferential direction. In the preferred embodiment just described, the gap(s) is/are possibly enlarged when the wrap is slid onto the axle tube, which, after all, increases the internal diameter of the wrap. Preferably, the wrap is then welded along the gap on the outer contour, wherein the weld pool may not advance towards the inner contour. Advantageously, the boundary area in the second state is formed less wide or more dense than in the first state.

Preferably, the compensation portion on the inner contour and/or on the outer contour forms at least one web, wherein a width of the at least one web in the circumferential direction preferably corresponds substantially to a gap width of a gap arranged adjacent to the at least one web in the circumferential direction. The compensation portion, thus, expediently has at least one web, preferably, however not necessarily, on the inner contour and/or on the outer contour. Preferably, such a web is formed on the two end portions. The webs are directed relative to each other such that when the wrap is compressed (in the circumferential direction), i.e. when the internal diameter is adjusted, the webs are pressed into the respective adjacent gaps. To put it differently, the gaps are adapted such that they are plastically deformable, making it possible to adjust the internal diameter of the wrap. Advantageously, in the second state, at least one web is moved farther into at least one adjacent gap than in the first state. Expediently, the compensation portion in the second state is at least partially plastically deformed.

Advantageously, the at least one web is arranged in the circumferential direction adjacent to the inner gap or the outer gap, wherein the at least one web is furthermore arranged in the radial direction adjacent to the gap of the respective opposite contour. Particularly preferably, on the inner contour two webs with respective adjacent gaps are formed, wherein substantially radially to the two webs a gap is formed in the outer contour. Advantageously, on the inner contour, in a radial direction when viewed towards the inner contour, the two webs limit the gap on the outer contour. Preferably, the gap width of the gap on the outer contour substantially corresponds to the sum of the gap widths of the gaps on the inner contour. Advantageously, it thus becomes possible to completely close the wrap so to say, by compressing it, as has already been described above. Thus, if the smallest internal diameter of the wrap is adjusted, there are no more gaps, advantageously. In the preferred embodiment, thus, the gap extends on the outer contour in the direction of the inner contour, wherein it transitions into the parting line and wherein in the circumferential direction of the wrap, when viewed to both sides of the parting line, the webs are arranged, adjacent to which in turn one respective gap is arranged.

Preferably, between two inner gaps and/or between two outer gaps an intermediate area is formed. The compensation portion, thus, expediently, has at least one intermediate area. Advantageously, a width of the intermediate area in the circumferential direction substantially corresponds to a sum of the gap widths of the adjacent gaps in this direction. Preferably, the intermediate area is formed in the form of the two already-described webs, however, the intermediate area explicitly has no parting line. Thus, the wrap is formed completely continuously in the area of the compensation portion(s). Since the intermediate area is deformable, which allows for a plastic deformation, it may be deformed or moved into the adjacent gap so to say when the wrap is compressed, for example, which makes it possible to adjust the internal diameter. Preferably, thus, two webs or the intermediate area on the inner contour or on the outer contour limit a gap on the opposite contour. Particularly preferably, the intermediate area is formed on the inner contour. In one embodiment, the intermediate area may also be arranged between an outer gap and an inner gap. Expediently, the outer gap and the inner gap are arranged displaced in the radial direction and connected by the intermediate area.

According to the invention, a method of manufacturing a compound of trailing arm and axle tube comprises the following steps:
providing a wrap;
providing an axle tube;
providing a trailing arm;
sliding the wrap onto the axle tube in order to position the wrap along a longitudinal direction of the axle tube;
actuating at least one compensation portion of the wrap by means of an adjustment force directed substantially along a circumferential direction of the wrap, and thus adjusting an internal diameter of the wrap to an outer diameter of the axle tube;
welding the wrap along the at least one compensation portion;
welding the wrap to the axle tube.
   Finally, the method comprises preferably also the step, according to which the trailing arm is positioned on the wrap and welded thereto.

Preferably, the method additionally comprises the following steps:
rotating the wrap until a hole of the wrap is arranged in a vertical direction on the axle tube;
welding the wrap along an outer gap of the wrap;
welding the wrap to the axle tube at least in a certain area along an inner contour of the hole of the wrap;
positioning the trailing arm on the wrap.

According to the invention, a method of manufacturing a compound of trailing arm and axle tube comprises the following steps:
providing a wrap;
providing an axle tube;
providing a trailing arm;
actuating at least one compensation portion of the wrap by positioning the wrap on the axle tube;
welding the wrap along the at least one compensation portion;
welding the wrap to the axle tube.
   Expediently, an internal diameter of the wrap is slightly smaller than an outer diameter of the axle tube so that the at least one compensation portion is actuated when the wrap is positioned on the axle tube. To put it differently, the wrap is slightly expanded and, thus, adjusted to the ideal internal diameter. Expediently, the method also comprises the step, wherein the trailing arm is positioned on the wrap and welded thereto.

Preferably, the method additionally comprises the step:
arranging the wrap in an accommodation of the trailing arm.
   By accommodating the wrap in the accommodation of the trailing arm, it is advantageously possible to carry out a first adjustment of the internal diameter of the wrap. Advantageously, thus, the internal diameter of the wrap is not only adjustable to an outer diameter of the axle tube, but also an outer diameter of the wrap is adjustable to an internal diameter of the accommodation of the trailing arm. Advantageously, the trailing arm, after the wrap has been positioned in the accommodation, is slid onto and positioned on the axle tube.

The features and advantages of the wrap apply analogously to the methods mentioned and vice versa.

According to the invention, a trailing arm for a vehicle axle has an accommodation, in particular for an axle tube, wherein the accommodation has an internal diameter, and wherein the accommodation has at least one compensation portion, and wherein the at least one compensation portion is adapted to modify the internal diameter by different adjustments. Preferably, however not necessarily, the compensation portion extends substantially along a longitudinal axis extending approximately transverse to a longitudinal extension of the trailing arm. The accommodation according to the invention may in the same manner fulfill the functions of the wrap of the invention. Therefore, it is a matter of course that all advantages and features of the wrap may also be transferred to the accommodation and vice versa. This applies in particular to the features, advantages and possibilities of designing and arranging the compensation portion. In the trailing arm of the type in question, the wrap is so to say integrated into the trailing arm and so to say forms the accommodation. Advantageously, thus, e.g. a substance-to-substance bond between the wrap and the trailing arm may be omitted, which due to the temperatures present often leads to material fatigue. Integrating the accommodation into the trailing arm advantageously offers many possibilities of designing the accommodation. Advantageously, the accommodation is formed e.g. by two beams running substantially parallel and in the circumferential direction. Transverse to the beams, i.e. in the direction of the axle tube, the beams are connected by at least one crossbeam, wherein the crossbeam comprises the compensation portion. Preferably, the beams are connected in particular by two crossbeams, which each comprise the compensation portion and which, when viewed transverse to the longitudinal direction of the axle tube, are arranged substantially opposite of each other. Due to the fact that the accommodation has two compensation portions, wherein each of the compensation portions advantageously has a parting line, the trailing arm is so to say two-part in the area of the accommodation so that expediently it can very easily be mounted at the axle tube, since it need not be inserted into the axle tube with much effort. Preferably, the trailing arm is welded directly to the axle tube, by means of spot welding, for example. Also here, the already-mentioned advantages mentioned in connection with the connection between the wrap and the axle tube apply again. Expediently, the trailing arm, which comprises the accommodation, is a cast part or a forged part. Equally preferably, the trailing arm comprising the accommodation may be manufactured from a plastic or composite material (preferably with carbon fibers) or also of combinations of the mentioned materials. Here, advantageously, the accommodation and the trailing arm are always formed as one part. Advantageously, the accommodation is designed such that at least partially it surrounds the axle tube in the circumferential direction and/or also transverse thereto such that between the axle tube and the trailing arm or the accommodation thereof a support is realized, which takes into account the flow of force.

Particularly preferably, the compensation portion has at least one parting line forming at least two end portions, wherein each end portion has at least one projection extending substantially along a circumferential direction of the axle tube, and wherein at least two projections engage into each other such that an inner gap and an outer gap are formed. Particularly preferably, the trailing arm has an accommodation, which is provided with two compensation portions, each having a respective parting line.

Further advantages and features become apparent from the following description of preferred embodiments of the wrap according to the invention, the method and the trailing arm according to the invention with reference to the appended Figures. Individual features of the various embodiments may be combined with each other within the scope of the invention.

### BRIEF DESCRIPTION OF THE DRAWINGS

The Figures show:

FIG. 1a shows a preferred embodiment of a compensation portion with two webs;

FIG. 1b shows a preferred embodiment of a compensation portion with an intermediate area;

FIG. 2 shows a preferred embodiment of a compensation portions with two projections;

FIG. 3 shows a preferred embodiment of a compensation portion with a continuous gap;

FIG. 4a shows a preferred embodiment of a compensation portion with a parting line and two gaps;

FIG. 4b shows a preferred embodiment of a compensation portion with an intermediate area and two gaps;

FIG. 5a shows a preferred embodiment of a wrap, arranged on an axle tube, in top plan view;

FIG. 5b shows a view of the preferred embodiment of the wrap, arranged on the axle tube, viewed in a longitudinal direction of the vehicle;

FIG. 6a shows a perspective view of a preferred embodiment of a trailing arm with an accommodation for an axle tube; and

FIG. 6b shows a perspective view of a preferred embodiment of a trailing arm with an accommodation and a hole.

### DETAILED DESCRIPTION OF THE PREFERRED EMBODIMENTS

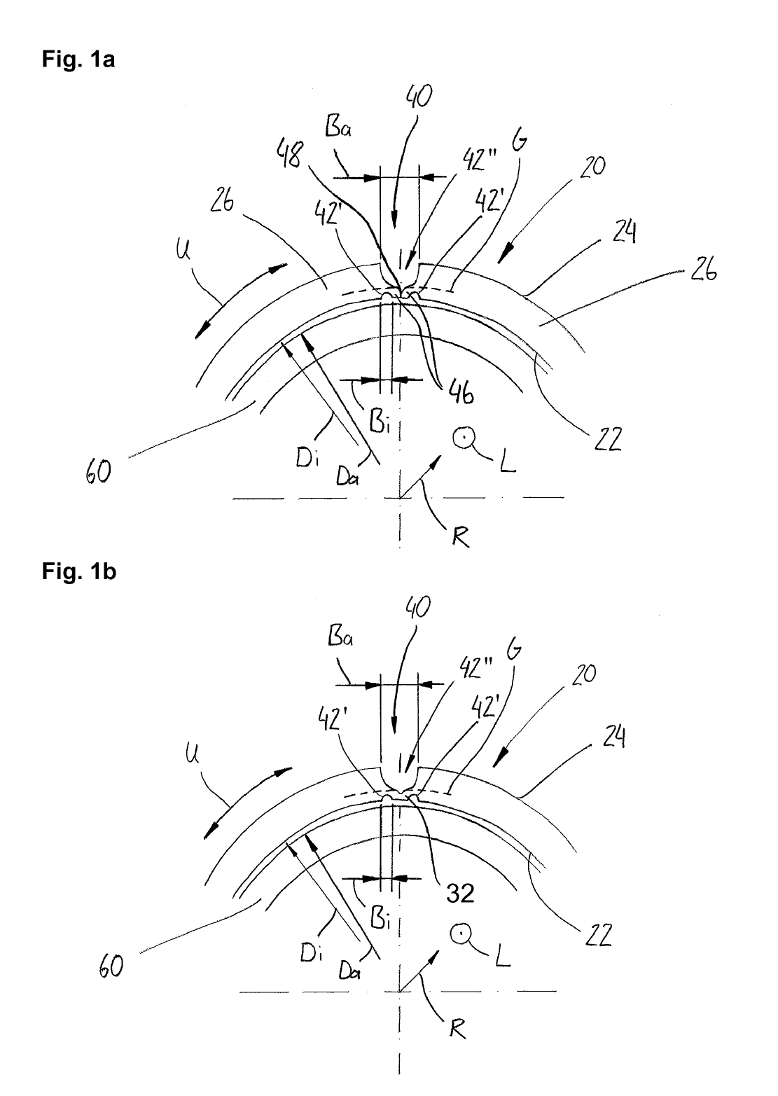

FIG. 1a shows a preferred embodiment of a compensation portion 40 with a parting line 48. At both sides of the parting line 48, in a circumferential direction U, two respective webs 46 extend, which in turn are also arranged in the circumferential direction U adjacent to one respective inner gap 42′. Substantially in a radial direction opposite the inner gap 42′, an outer gap 42″ is arranged on an outer contour 24. The outer gap 42″ on the outer contour 24, when viewed in the circumferential direction U, substantially has a gap width Ba corresponding substantially to the gap widths Bi of the inner gaps 42′. Advantageously, the gap width Ba on the outer contour 24 may also be formed larger than the gap widths Bi of the inner gaps 42′ such that when the wrap 20 is fully compressed, sufficient space remains for a fillet weld in the outer gap 42″ of the outer contour 24. By means of the compensation portion 40 of the wrap 20 an internal diameter Di of the wrap 20 can be adjusted to an outer diameter Da of an axle tube 60. By arranging and designing the webs 46, a boundary area G is formed, which, so to say viewed from the outer contour 24 in the direction of the inner contour 22, forms a limit, which cannot be passed by locking agents or a weld pool or the like. Advantageously, this makes it possible to avoid the notching effect onto the axle tube 60 or too great a heat input into the axle tube 60. The axle tube 60 as well as the wrap 20 extend substantially along a longitudinal axis L.

As regards FIG. 1b, what has been said with respect to FIG. 1a applies. The difference, however, consists in that instead of two webs 46 an intermediate area 32 is formed on an inner contour 22.

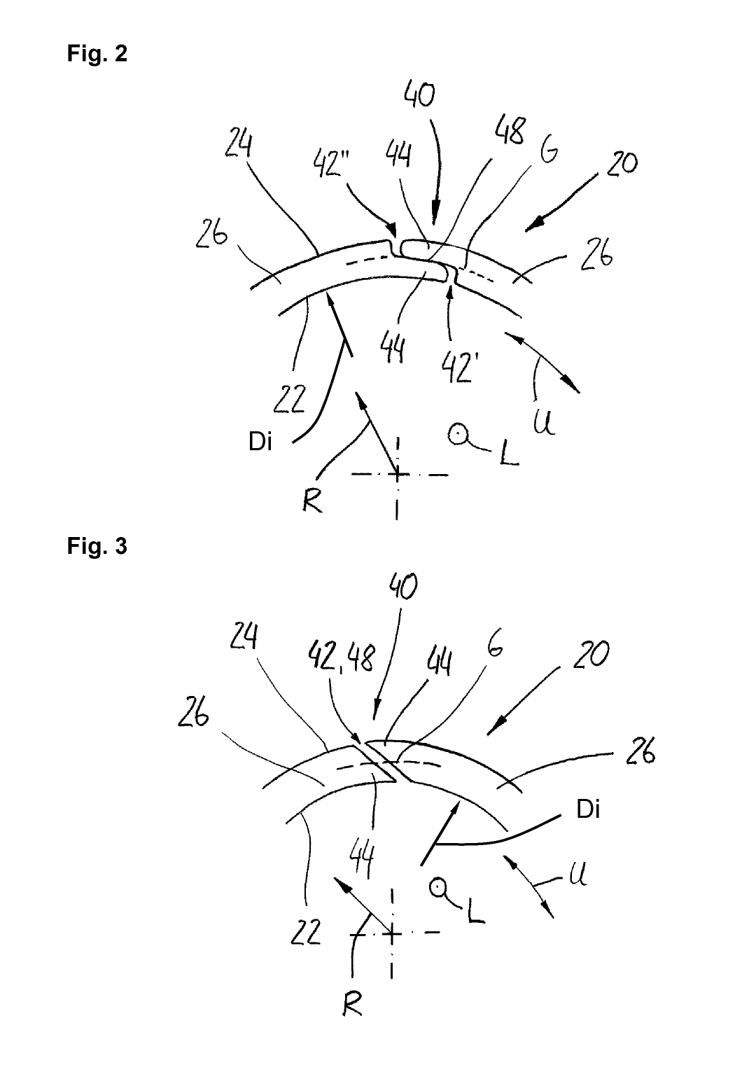

FIG. 2 shows a preferred embodiment of a compensation portion 40 with a parting line 48 separating a wrap 20 into two end portions 26. The end portions 26 each form a projection 44 forming a boundary area G. The projections 44 as well as the boundary area G extend substantially along a circumferential direction U. At an outer contour 24 and an inner contour 22 respective gaps 42′ and 42″ are formed, by means of which an internal diameter Di of the wrap 20 can be adjusted.

FIG. 3 shows a preferred embodiment of a compensation portion 40 with a parting line 48 formed as a continuous gap 42 between an outer contour 24 and an inner contour 22 of the wrap 20. The gap 42 extends not substantially parallel to a radial direction R of the wrap 20, but is arranged inclined thereto. Although in this embodiment a continuous gap 42 is formed between the outer contour 24 and the inner contour 22, a boundary area G can be formed by the shape and position of the gap 42, which boundary area acts as a limit for a locking agent or a weld pool, which might flow from the outer contour 24 in the direction of the inner contour 22. As is already known, an internal diameter Di of the wrap 20 can be adjusted by means of the gap 42.

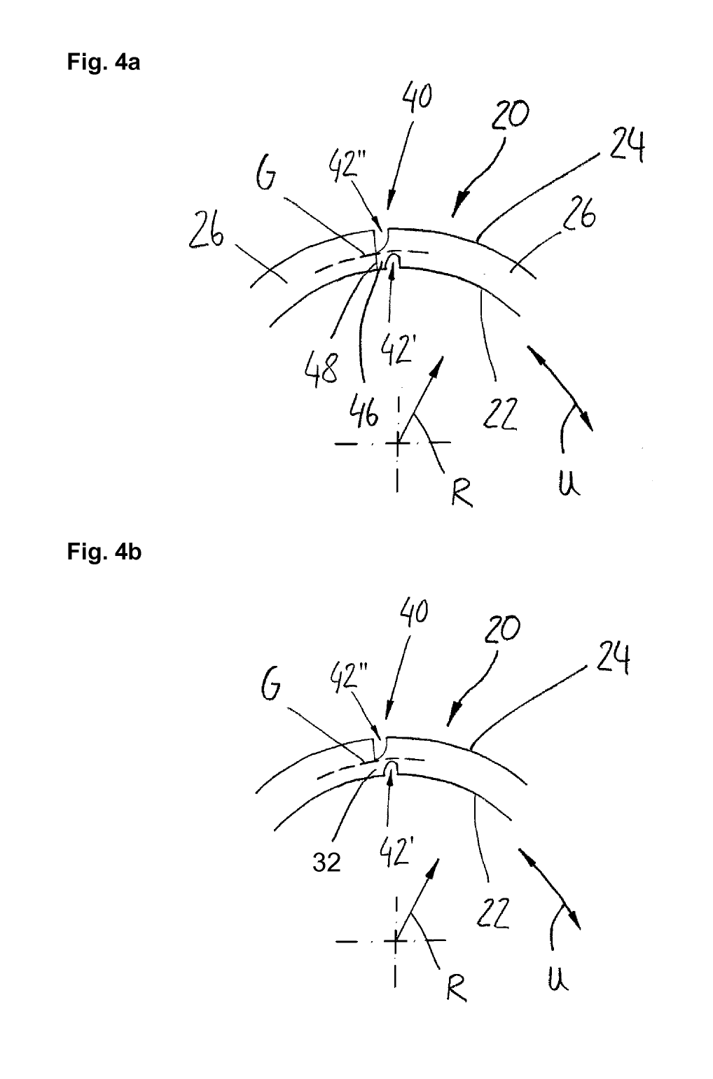

FIG. 4a shows a preferred embodiment of a compensation portion 40 with a parting line 48 forming two end portions 26. At the right-hand portion 26, on an inner contour 22, an inner gap 42′ is formed, which is arranged adjacent to a web 46 viewed in a circumferential direction U. Substantially in a radial direction R to the web 46 or to the inner gap 42′ an outer gap 42″ is arranged at an outer contour 24. The web 46 together with the left-hand end portion 26 forms a boundary area G.

What has been said with respect to FIG. 4a applies also to FIG. 4b. There is a difference in that there is no parting line 48, but an intermediate area 32 is formed at an inner contour 22.

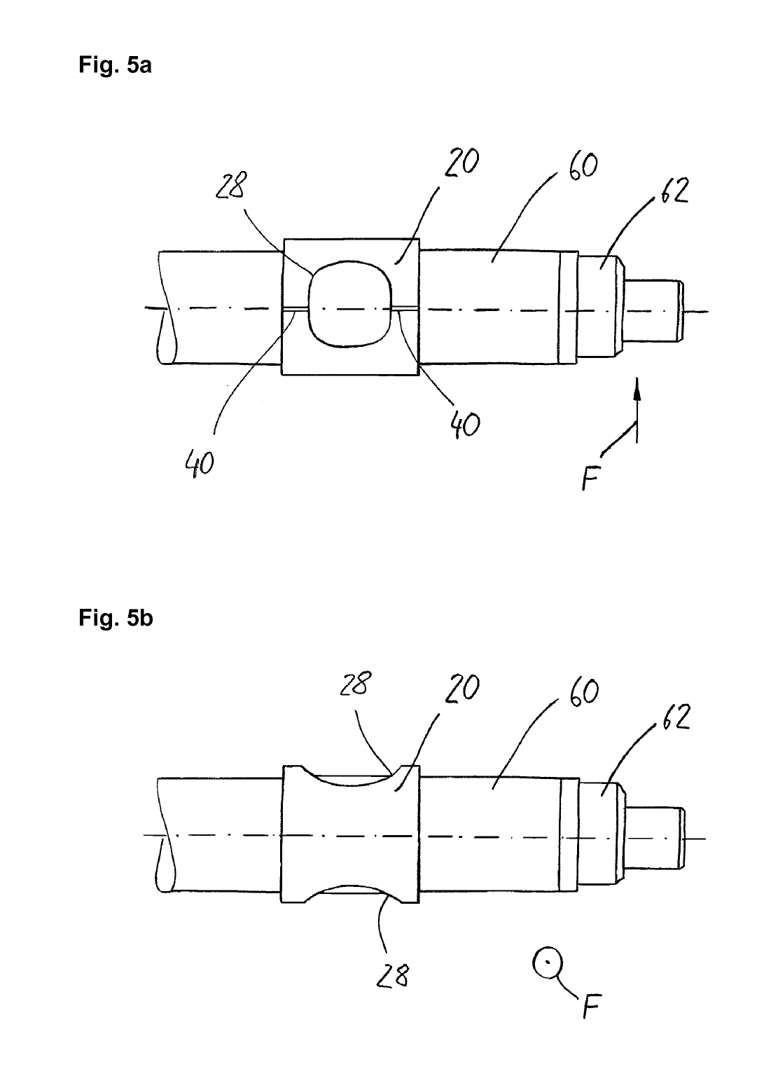

FIG. 5a shows a preferred embodiment of a wrap 20, arranged on an axle tube 60, in a top plan view. The wrap 20 is provided with a hole 28 serving to make the wrap 20 weldable to the axle tube 60 by means of plug welding. Substantially transverse to a direction of travel F, two compensation portions 40 extend, which are separated so to say by the hole 28. Along the compensation portions 40 or the outer gaps 42″ thereof (not shown in FIG. 5a) the wrap 20 is preferably welded, after it has been adjusted to the ideal internal diameter so to say. An axle stub 62 is arranged in a longitudinal axis L of the axle tube 60.

FIG. 5b shows the embodiment preferred from FIG. 5a of the wrap 20 in a perspective viewed in the direction of travel. It can be seen that substantially parallel to a horizontal plane of the axle tube 60, at which the axle stub 62 is arranged, the two holes 28 are arranged.

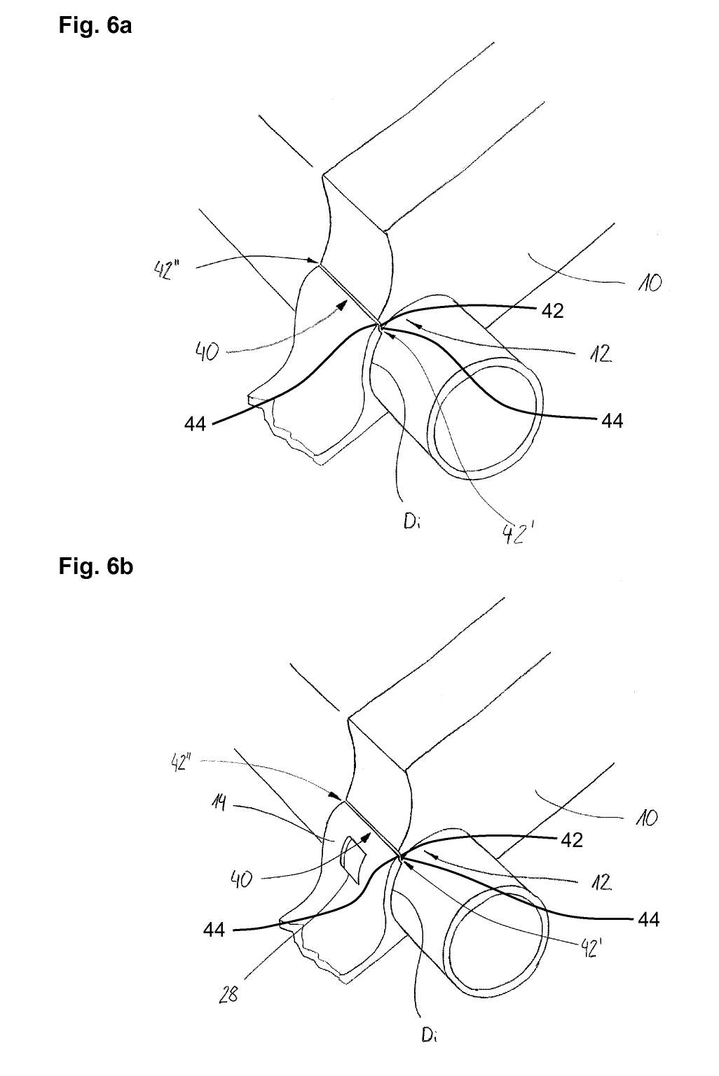

FIG. 6a shows a perspective view of a preferred embodiment of a trailing arm 10 with an accommodation 12. The accommodation 12 is provided with a compensation portion 40, by means of which an internal diameter Di of the accommodation 12 may be ideally adjusted to an outer diameter of an axle tube (without reference numeral). At the compensation portion 40, two projections 44 are formed forming an inner gap 42′ and an outer gap 42″. The inner gap 42′ and the outer gap 42″ are connected such that a continuous gap 42 is formed.

FIG. 6b shows a perspective view of a preferred embodiment of a trailing arm 10 with an accommodation 12 and a hole 28. The accommodation 12 is provided with a compensation portion 40, by means of which an internal diameter Di of the accommodation 12 may be ideally adjusted to an outer diameter of an axle tube (without reference numeral). The accommodation comprises the hole 28. Advantageously, the hole 28 serves to weld the trailing arm 10 onto the axle tube, for example. At the compensation portion 40, two projections 44 are formed forming an inner gap 42′ and an outer gap 42″. The inner gap 42′ and the outer gap 42″ are connected such that a continuous gap 42 is formed.

### LIST OF REFERENCE SIGNS

10 trailing arm
12 accommodation
20 wrap
22 inner contour
24 outer contour
26 end portion
28 hole
32 intermediate area
40 compensation portion
42 gap
42′ inner gap
42″ outer gap
44 projection
46 web
48 parting line
60 axle tube
62 axle stub
G boundary area
Ba, Bi gap widths
Di internal diameter (wrap)
Da outer diameter (axle tube)
U circumferential direction
L longitudinal axis
R radial direction
F direction of travel

1-14. (canceled)

15. A wrap for attaching a trailing arm to an axle tube, having a substantially tubular cross-section that extends along a longitudinal axis, an outer contour and an inner contour;
wherein the inner contour has an internal diameter;
wherein the wrap has at least one compensation portion, which extends substantially along the longitudinal axis;
wherein the at least one compensation portion is configured to modify the internal diameter;
wherein the compensation portion includes at least one of an inner gap having a gap width and arranged at the inner contour and an outer gap having a gap width and arranged at the outer contour configured to modify the internal diameter;
wherein at least one of the inner gap and the outer gap extends substantially along the circumferential direction of the wrap; and
wherein the internal diameter may be modified by modifying at least one of the gap width of the inner gap and the gap width of the outer gap.

16. The wrap of claim 15, wherein the at least one of the inner gap and the outer gap include an inner gap and an outer gap, and wherein the gap width of the outer gap substantially corresponds to the gap width of the inner gap.

17. The wrap of claim 16, wherein the compensation portion has at least one parting line extending substantially along the longitudinal axis, and comprising at least two end portions on the wrap.

18. The wrap of claim 17, wherein each of the end portions has at least one projection extending substantially along the circumferential direction of the wrap, and wherein at least one projection of each of the end portions engage into each other such that the inner gap and the outer gap are formed.

19. The wrap of claim 18, wherein the compensation portion comprises at least one web on the at least one of the inner contour and on the outer contour, and wherein a width of the at least one web in the circumferential direction corresponds substantially to the gap width of the at least one of the inner gap and the outer gap arranged in the circumferential direction adjacent to the web.

20. The wrap of claim 19, wherein the at least one web in the circumferential direction is arranged adjacent to at least one of the inner gap and the outer gap, and wherein the at least one web is additionally arranged in the radial direction adjacent to the gap of the respective opposite contour.

21. The wrap of claim 20, wherein the compensation portion has at least one intermediate area, and wherein the intermediate area is plastically deformable.

22. The wrap of claim 21, wherein the internal diameter may be adjusted by a plastic deformation of at least one of the at least one web and of the at least one intermediate area.

23. The wrap of claim 15, wherein the compensation portion has at least one parting line extending substantially along the longitudinal axis, and comprising at least two end portions on the wrap.

24. The wrap of claim 23, wherein each of the end portions has at least one projection extending substantially along the circumferential direction of the wrap, and wherein at least one projection of each of the end portions engage into each other such that the inner gap and the outer gap are formed.

25. The wrap of claim 15, wherein the compensation portion comprises at least one web on the at least one of the inner contour and on the outer contour, and wherein a width of the at least one web in the circumferential direction corresponds substantially to the gap width of the at least one of the inner gap and the outer gap arranged in the circumferential direction adjacent to the web.

26. The wrap of claim 25, wherein the at least one web in the circumferential direction is arranged adjacent to at least one of the inner gap and the outer gap, and wherein the at least one web is additionally arranged in the radial direction adjacent to the gap of the respective opposite contour.

27. The wrap of claim 15, wherein the compensation portion has at least one intermediate area, and wherein the intermediate area is plastically deformable.

28. The wrap of claim 27, wherein the internal diameter may be adjusted by a plastic deformation of at least one of the at least one web and of the at least one intermediate area.

29. A method of manufacturing a compound of trailing arm and axle tube, comprising:
providing a wrap;
providing an axle tube;
providing a trailing arm;
sliding the wrap onto the axle tube and positioning the wrap along a longitudinal direction of the axle tube;
actuating at least one compensation portion of the wrap by an adjustment force which is directed substantially along a circumferential direction of the wrap, thus adjusting an internal diameter of the wrap to an outer diameter of the axle tube;
welding the wrap along the at least one compensation portion; and
welding the wrap to the axle tube.

30. The method of claim 29, further comprising:
rotating the wrap until a hole of the wrap is arranged on the axle tube in a vertical direction;
welding the wrap along an outer gap of the wrap;
welding the wrap to the axle tube at least in a certain area along an inner contour of the hole of the wrap; and
positioning the trailing arm on the wrap.

31. A method of manufacturing a compound of trailing arm and axle tube, comprising:
providing a wrap;
providing an axle tube;
providing a trailing arm;
actuating at least one compensation portion of the wrap by positioning the wrap on the axle tube;
welding the wrap along the at least one compensation portion; and
welding the wrap to the axle tube.

32. The method of claim 31, further comprising:
arranging the wrap in an accommodation of the trailing arm.

33. A trailing arm for a vehicle axle, comprising:
an accommodation for an axle tube, wherein the accommodation has an internal diameter, and wherein the accommodation has at least one compensation portion;
wherein the at least one compensation portion is configured to modify the internal diameter;
wherein the compensation portion includes at least one of an inner gap having a gap width and arranged at the inner contour and an outer gap having a gap width and arranged at the outer contour is configured to modify the internal diameter;
wherein at least one of the inner gap and the outer gap extend substantially along the circumferential direction of the wrap; and
wherein the internal diameter may be modified by modifying at least one of the gap width of the inner gap and the gap width of the outer gap.

34. The trailing arm of claim 33, wherein the compensation portion has at least one parting line comprising at least two end portions, wherein each end portion has at least one projection extending substantially along a circumferential direction of the axle tube, and wherein the at least one projection of each end portion engage into each other such that an inner gap and an outer gap are formed.
